(19) United States
(12) Patent Application Publication
(10) Pub. No.: US 2007/0168282 A1
(43) Pub. Date: Jul. 19, 2007

(54) Systems and/or methods for simplifying payment systems, and payment instruments implementing the same

(75) Inventor: Joseph A. Giordano, Centreville, VA (US)

Correspondence Address: NIXON & VANDERHYE, PC, 901 NORTH GLEBE ROAD, 11TH FLOOR, ARLINGTON, VA, 22203, US

(73) Assignee: Advanced Payment Products, LLC, Centreville, VA (US)

(21) Appl. No.: 11/653,374

(22) Filed: Jan. 16, 2007

Related U.S. Application Data
(60) Provisional application No. 60/758,556, filed on Jan. 13, 2006.

(51) Int. Cl. G06Q 40/00

(52) U.S. Cl. 705/40

(57) ABSTRACT

The exemplary embodiments described herein relate to systems and/or methods for simplifying payment systems, and payment instruments implementing the same. In particular, certain exemplary embodiments relate to a single payment device (e.g., a card) with multiple magnetic strips, a single payment device being linked to multiple accounts, a single payment device having a button required before transmission of payment information, and/or a single payment device being linked to a sub-account (e.g., a petty cash account).

### CROSS-REFERENCE TO RELATED APPLICATION

This application claims the benefit of U.S. Application Ser. No. 60/758,556, filed on Jan. 13, 2006, the entire contents of which are incorporated herein by reference.

### FIELD OF THE INVENTION

The exemplary embodiments described herein relate to systems and/or methods for simplifying payment systems, and payment instruments implementing the same. In particular, certain exemplary embodiments relate to a single payment device (e.g., a card) with multiple magnetic strips, a single payment device being linked to multiple accounts, a single payment device having a button required before transmission of payment information, and/or a single payment device being linked to a sub-account (e.g., a petty cash account).

### BACKGROUND AND SUMMARY

Payment systems have existed almost as long as there have been sales of any kind. To facilitate such sales, the exchange of money for a good replaced the bartering system. Payment systems have evolved yet further to include payment instruments including, for example, credit cards, debit cards, checks, etc. Indeed, a market for payment systems has developed, prompting providers of payment instruments to brand their products, offer incentives and tie-ins, etc.

Unfortunately, however, these current payment instruments and their concomitant marketing strategies suffer from several drawbacks. For example, one drawback relates to difficulties may consumers face managing the ever-increasing number of credit and/or debit cards they have. Most consumers today have more than one bank account to fund their daily lives and, on average, each consumer carries four or more credit and/or debit cards. Often, the multiple bank accounts are dispersed between multiple banks. A consumer typically also carries membership and/or identification cards for a gym, one or more grocery stores and/or pharmacies, discount clubs, medical and insurance identification, airline and travel cards, etc. If lost or stolen, consumers face a time-consuming process to cancel and replace each and every card.

Another drawback consumers face relates to controlling the flow of funds. Although most consumers have access to account activity for each card through a website, the activity displayed is either not delivered in real-time, or is not actionable in a timely, easily accessible fashion. Consumers are offered few options for controlling and/or monitoring their accounts and/or spending habits. For example, there typically is no user-defined notification to reduce or track spending per category or activity within a particular month or pay-period, a feature provided by certain exemplary embodiments of the present invention.

Also, although most consumers are protected with zero liability protection for most credit card products, fraudulent access still occurs. When this happens, consumers are inconvenienced by the laborious process of correcting accounts, credit reports, and merchant relationships. Indeed, the process can take months or even years. More than being inconvenienced, consumers may experience fear that their financial assets may be stolen by undetected fraudulent means, including, for example, unauthorized account access, etc.

For example, one type of fraudulent accession may be accomplished via a passive read of RFID tags embedded on a payment instrument. With the increasing implementation of passively read RFID payment devices, there is increased risk of user account theft by sophisticated readers and antennae systems to steal ID numbers. Currently, the RFID capability embedded in cards uses only encryption algorithms to prevent such unauthorized reads from close proximity. A motivated thief could build a reader that breaks the encryption and security algorithms and access a user's information without the user's knowledge.

Another drawback apart from these vulnerabilities relates to the difficulty of using the payment instruments. For example, consumers often find it difficult to swipe cards at a point-of-sale. Most of today's retailers have implemented self-serve payment terminals to speed transactions. Yet, many consumers find swiping cards through a magnetic-strip reader confusing and complex. Consumers struggle with how to orient their cards properly in the readers, having to properly orient their cards (e.g., by distinguishing the front and back and top and bottom) before they can be read. Additionally, the cards often fail because of the contact nature of the magnetic strip technology.

A consumer also may experience difficulties using a payment instrument when making an Internet purchase and/or payment. Making payments via the Internet often requires cumbersome computer-mediated prompts requiring a growing amount of information input by the consumer. Each merchant's purchase process is different. Frequently, even with the software processes and precautions, consumers' card numbers are still stolen in connection with Internet transactions. Because of the risks, consumer's still restrict their Internet-based commerce. Thus, even with the convenience of Internet shopping, more than 90% of transactions still occur in traditional brick-and-mortar stores. The Internet's transaction potential is greatly under-utilized by the lack of easy to use websites with safe, secure, easy-to-use payment for product and services.

Still another drawback relates to product delivery systems. Currently, there typically are at least three brands marketed on a given card product including the Network brand, the customer relationship brand and, in some cases, the bank brand. Current payment products are defined by a combination of systems and marketing provided by the network and the bank. The brand closest to the customer has little-to-no voice in the product definition. Further, many of the bank's systems are outsourced to “Issuing Processors.” As a result, the entity closest to the customer has little-to-no input into the customer offer or product design. Predictably, there have been few successful consumer products developed in the last thirty years. For this to change, the product system may be separated from the network and the bank system with control of the system resting with the customer relationship brand or their agent, as may be done in certain exemplary embodiments of this invention.

Thus, it will be appreciated that there is a need in the art for systems and methods for simplifying payment systems, and payment instruments implementing the same.

Certain exemplary embodiments described herein may be used separately or in various combinations. Thus, certain exemplary embodiments may have one or more of the following illustrative aspects.

One aspect of certain exemplary embodiments relates to quick and easy identification and/or orientation of the card. The confusion associated with card orientation at the point-of-sale is reduced by having one or more magnetic strips embedded on various edges of the card. Terminal, store, and host systems do not necessarily have to be updated because the readers may receive the needed data in the same format as is received today from conventional magnetic-strip cards. To further enhance card readability, a contact-free RFID chip also may be enclosed in the card that is read only when in close proximity to a RFID-chip reader. With the proliferation of electronic devices available today, existing devices could be reconfigured to include a contact-less chip to enable the device to also be used as an access device for payments.

Another aspect of certain exemplary embodiments relates to reducing the need for multiple account cards to access and/or use multiple accounts. By merging account data for both credit and debit accounts into one card, consumers may reduce the number of cards they need to carry. Some dual network cards exist today, but they only access one checking account. With these existing cards, consumers can select debit or credit when the card is swiped. Today, when either the “credit” or “debit” button is pushed at the point-of-sale, the transaction is processed differently, but the checking account is ultimately debited. The selection merely indicates the network through which the card should be routed. By contrast, according to an aspect of certain exemplary embodiments, the consumer may make the choice at the point-of-sale, but the end result is different. For example, a debit transaction may access the checking account and a credit transaction may apply to the consumer's credit account. Furthermore, the user may be able to debit any checking account, even if the checking account is with a different bank than the credit account.

Still another aspect of certain exemplary embodiments relates to organized spending via a sub-account. A designated debit account may be accessed automatically for amounts under a certain threshold (e.g., $10, $20, etc.) by setting up a sub-account for ‘petty cash’ transactions. Once the sub-account balance reaches a user-set level, an amount of money may be automatically debited or transferred from the main checking account to replenish the petty cash sub-account. The consumer may able to control sub-account spending by setting limits, for example, of $35 to $50. Also, the consumer may specify if the account requires PIN access or not.

A further aspect of certain exemplary embodiments relates to automatic identification. A card or ID device may be used as an access device for third party membership or reward programs. When a consumer uses the card, a membership ID number may be packed into the data record of a card transaction and returned to the point of identification for access. Then, with collaboration from the membership rewards program, any access, rewards redemption, or rewards credit may be processed. The consumer is able to set-up any membership and/or reward accounts to be linked in advance, for example, via a web-site or IVR.

Still a further aspect of certain exemplary embodiments relates to rewards simplification. Consumers may reduce the number of reward cards and/or coupons from their wallets with the use of a device. Their coupons and reward cards may be scanned into a small device using imprinted bar codes. The device may be a key ring fob, a card, a cell phone, a PDA, or any other device that has an input port (wired or wireless) to receive bar code data. It may include a screen to display the data scanned from the bar code and a few keys or buttons to enable the consumer to select the coupon or reward displayed on the screen. Using this device, a user may quickly scroll through and mark the applicable coupons or reward cards at check-out via the screen on the device. The clerk then may scan the coupons or reward codes, for example, from an image on the display rather than a paper coupon or card, and presses one button to scroll to the next coupon. When the list of “marked” coupons is complete, the clerk may be notified. This may provide the benefits of not having to carry multiple reward cards or coupons, while not requiring significant re-training of store personnel, and not requiring changes to the existing merchant system. If in-store equipment is modified, the coupons and/or reward program information may be transmitted in more complicated ways (e.g., wirelessly, in batch, etc.).

An aspect of certain exemplary embodiments relates to secure access via a card using a set of rules. Consumers may control how the card is used by requiring a PIN for user-defined purchases. For example, they may define and limit the amount of purchases, control when the card is activated for use, and specify other rules. One rule may include requiring the use of a PIN for a debit account but not for a credit account when multiple accounts are tied to one card. By way of example and without limitation, the rules may be stored in a database, e.g., accessibly by the product system 100 of FIG. 1.

Another aspect of certain exemplary embodiments relates to the ability to track, monitor, and/or control purchases. With real-time (or near real-time) transactions available (e.g., in a database), a user may be notified when certain warning conditions were triggered and, if desired, certain types of transactions may be blocked. The user may set up certain rules or thresholds via the Internet for each card or device. If a warning condition occurs, the user may notified (e.g., via a phone call, e-mail, or text message), for example, based on prior user setup. Additionally or in the alternative, the user may request that transactions that meet certain conditions be declined at the point of sale. Examples of warning conditions include, for example, exceeding a daily or monthly spending limit, exceeding a transaction size, an international transaction, two transactions close together in different geographic locations, etc. This aspect may help to transfer fraud monitoring to the user, thus reducing costs for the bank and/or reducing fraud for both the bank and the consumer.

Another aspect of certain exemplary embodiments relates to a product delivery system. The transaction flow may be re-routed to enable the implementation of a product system that enables the customer relationship brand to control the product offer for the consumer. The Issuing System may be combined with, or integrated into, a separate system that delivers such product features. The change in process flow may be on the “back end” so that the merchant point-of-sale and merchant processing systems do not need to be changed to implement corresponding product features.

In certain exemplary embodiments, a payment instrument comprising a card on which at least two account identifiers are disposed is provided. Each said account identifier may be disposed proximate to an edge of the card. The account identifiers may be disposed on one or both sides of the card and/or on one or both ends of a single side of the card. The account identifiers may be magnetic strips in certain exemplary embodiments.

In certain other exemplary embodiments, a product system operable to route a transaction in dependence on a payment type selected by a user at a point-of-sale after the user presents a single payment instrument at the point-of-sale is provided. When the payment type is indicative of a credit transaction, the product system may be configured to route the transaction by posting the transaction to a billing system as a credit card transaction. When the payment type is indicative of a debit transaction, the product system may be configured to route the transaction by identifying a debit account and a bank associated with the debit account and debiting the identified debit account in accordance with procedures of the identified bank.

Still other exemplary embodiments provide a method of routing a payment transaction. A payment type may be received at a point-of-sale. The payment transaction may be routed in dependence on the selected payment type. When the selected payment type is a credit, the payment transaction may be posted to a billing system as a credit card transaction. When the selected payment type is a debit, a debit account and a bank associated with the debit account may be identified and the identified bank account may be debited in accordance with procedures of the identified bank.

According to certain exemplary embodiments, a method of routing a payment transaction initiated by a user at a point-of-sale is provided. Details of the payment transaction may be received from a point-of-sale system. Whether the payment transaction details match one or more criteria specified by the user in advance of the payment transaction may be determined. When there is a match, a sub-account of a main account associated with a payment instrument presented by the user at the point-of-sale may be charged. When there is not a match, the main account associated with the payment instrument presented by the user may be charged. In certain exemplary embodiments, when the sub-account drops below a threshold level of funds, replenishing the sub-account with funds from the main account.

According to still other exemplary embodiments, a payment instrument associated with an bank account is provided. The payment instrument may include a transmitter for wirelessly transmitting information about the bank account to a point-of-sale system to complete a payment transaction. The payment instrument also may include transmission enabling logic circuitry having a first state indicative of enabled transmission and a second state indicative of disabled transmission. The transmitter may be configured to transmit the bank account information in dependence on the state of the transmission enabling logic circuitry.

### BRIEF DESCRIPTION OF THE DRAWINGS

These and other features and advantages will be better and more completely understood by reference to the following detailed description of exemplary illustrative embodiments in conjunction with the drawings, of which:

FIG. 1 is a current transaction flow with a product system of certain exemplary embodiments inserted into the flow;

FIG. 2A is front view of a payment card, in accordance with an exemplary embodiment;

FIG. 2B is a back view of the payment card of FIG. 2A, in accordance with an example embodiment;

FIG. 3 is an illustrative flowchart showing a transaction involving a single card having access to multiple accounts, in accordance with an exemplary embodiment;

FIG. 4 is an illustrative flowchart showing a transaction where a petty cash sub-account is linked to another of the user's account and is accessible by a payment device, in accordance with an exemplary embodiment;

FIG. 5 is an illustrative flowchart showing a transaction where a single device stores one or more coupons and/or rewards programs, in accordance with an exemplary embodiment; and,

FIG. 6 is an illustrative flowchart showing a transaction limited by one or more user-specified rules.

### DETAILED DESCRIPTION

The exemplary embodiments described herein relate to systems and/or methods for simplifying payment systems, and payment instruments implementing the same. As will be appreciated, the techniques described herein may be used in alone and/or in various combinations.

### I. Inserting a Product System into a Standard Financial Transaction without Disrupting the Existing Merchant Transaction Flow

Certain exemplary embodiments relate to techniques for inserting a product system into a standard financial transaction without disrupting the existing merchant transaction flow. The brand may develop innovative products by controlling the specifications to the system, while the brand and its payment product(s) work with one or more banks and/or one or more merchant and/or banking networks (e.g., Visa, AmEx, ACH, Plus, Pulse, etc.).

Currently, the product specification is controlled by the network and each bank controls its own system. However, according to certain exemplary embodiments, the co-brand entity may have its own system that interfaces with banks and sits in the middle of the payment transaction as an Issuing Processor. Additionally or in the alternative, the co-brand entity may integrate closely with an existing Issuing Processor. By controlling the system, the brand can develop its own products, negotiate as good a deal as possible with banks (e.g., as enabled by the controlling of the system), and fully monetize its brand value.

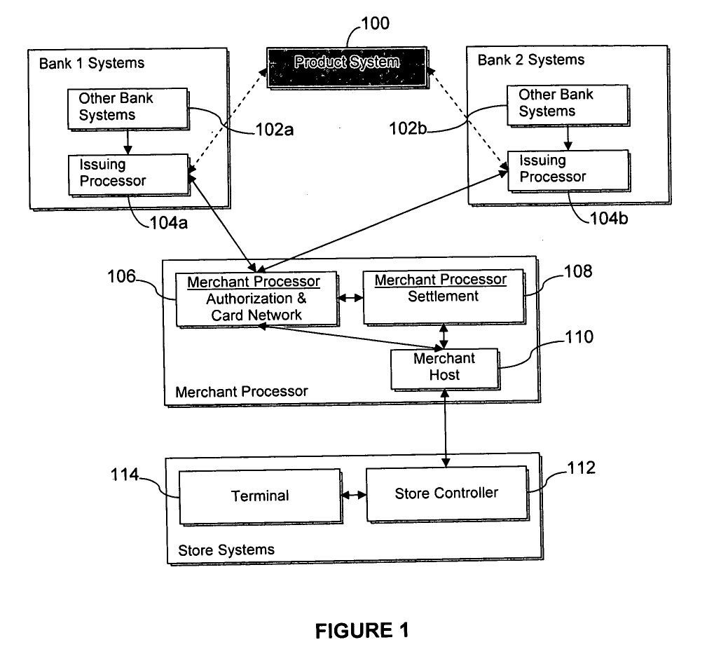

FIG. 1 shows a current transaction flow with a product system 100 of certain exemplary embodiments inserted into the flow. FIG. 1 generally shows an arrangement where the product system 100 of certain exemplary embodiments may be thought of as helping to revise the conventional process flow to accommodate unique product features (e.g., those described below). Also, in certain exemplary embodiments, the product system and issuing processor(s) 104 may be combined to provide, for example, a more cost-effective solution. Issuing banks may provide cards to consumers and use both internal systems and outsourced card operation systems.

The merchant host system may capture all (or substantially all) of the store transaction data in real-time (or substantially real-time). Certain merchant host systems settle such transactions once a day (e.g., typically via a nightly batch process), whereas others settle transactions individually, in smaller groups, etc. The merchant processor may fund the merchant based on the captured transactions on, for example, a day-to-day basis.

The store systems may read and process credit and debit transactions. They also may communicate in real-time (or substantially real-time) with the host data capture systems.

Referring to the particular exemplary embodiment shown with reference to FIG. 1, there are a two bank systems shown in FIG. 1. Each bank system includes a link to other bank systems 102a-b which, in turn, is linked to the bank's own issuing processor 104a-b. The product system 100 also is linked to each respective issuing processor 104a-b. It will be appreciated, of course, that the bank systems are shown in greatly simplified schematics. Also, it will be appreciated that although only two bank systems are shown in FIG. 1, the present invention is not limited to exactly two bank systems.

Each issuing processor is linked to the merchant processor via the merchant processor's connection to the authorization and card network 106. The merchant processor's connection to the authorization and card network 106 then is connected to the settlement system 108, and both the merchant processor's connection to the authorization and card network 106 and the settlement system 108 are connected to the merchant host system 110. In some cases, a merchant may operate its own merchant host 110 (e.g., if it is a large merchant), whereas in other cases merchants may contract with one or more third parties to provide such services.

The merchant host 110 is connected to the in-store systems via a store controller 112, which is linked to the actual terminal 114. Of course, it will be appreciated that the descriptions of the merchant processor and the store systems have been greatly simplified for ease of description. It also will be appreciated that any number of store systems may be implemented, and each store system may have any number of terminals 114 connected to the merchant processor.

The Product System can be used with one or more Issuing Processors and one or more banks. One card product potentially may have one or more banks providing credit, and/or one or more banks providing bank accounts to be debited. In one exemplary embodiment, the product system may enable the brand to designate a preferred bank to provide credit on a user-by-user basis. For example, a user may designate and/or re-designate a preferred bank through an automated system process (e.g., over the phone, via the Internet, etc). Within this process, the user may provide identifying information and the permission to perform a credit check. The system may evaluate the customer, and query multiple banks to determine the credit terms that each bank provide to the consumer and the revenue split that the each bank agrees to. The system may calculate the best offer and make that bank the credit bank for that user. This entire process may be transparent to the customer, or the user may be informed as the process continues. The customer may be approved according to credit terms specified by the bank, and the terms may be offered to the user for acceptance. This process may occur in real-time with the bank selection being transparent to the end-user (except as provided in the terms of use and other legal documentation). From a debit standpoint, the user may select any bank checking account that they desire for debit-based features.

Additionally, certain exemplary embodiments may provide other information-based features, including, for example, common account access to both credit and debit accounts from one or more different banks, access to any bank debit account from a common card, the ability to determine the bank credit relationship on a customer-by-customer basis, etc.

It will be appreciated that the flow depicted with reference to FIG. 1 may serve as the basis for one or more of the exemplary embodiments described below. Additionally or in the alternative, the exemplary embodiments described below may be implemented apart from the underlying flow depicted with reference to FIG. 1, each being implemented alone or in various combinations.

### II. Card with a Magnetic Strip on Multiple Edges

Certain exemplary embodiments provide a card with a magnetic strip on multiple edges of the card. Currently, when a customer swipes a card, the customer must orient the card in the proper direction so that the card-reader can read the magnetic strip correctly. Many terminals try to communicate the proper orientation with a graphic at the point of sale. However, it often is difficult to communicate the proper orientation for the card using a two dimensional graphic.

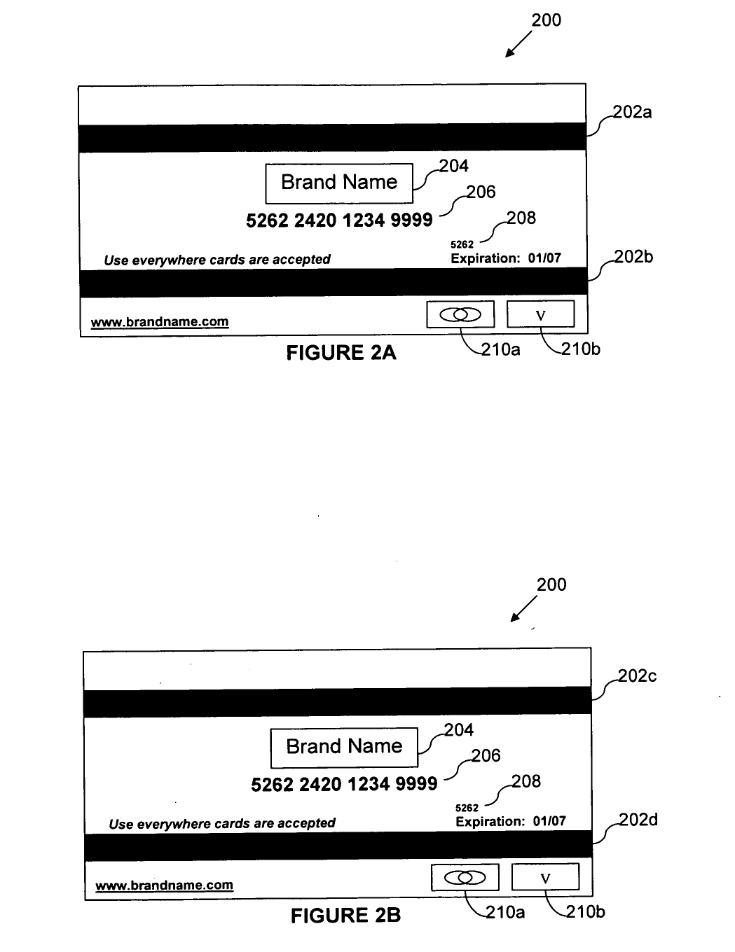

FIGS. 2A and 2B show a multiple-edge magnetic strip card, in accordance with an exemplary embodiment. Duplicate information may be stored on (e.g., encoded in) each magnetic strip. The card may have multiple strips on two, three, or four edges, for example. The multiple-edge card may enable the user to insert the card without concern for the orientation of the reader. Accordingly, if such a card were swiped through a conventional card-reader, the data stored in the magnetic strip would pass through the system just as it does today.

In certain exemplary embodiments, the same information would be included on each of the magnetic strips so it does not matter to the card reader which strip ultimately is read. In certain other exemplary embodiments, each strip may include different data, for example, to enable access to multiple accounts via a single card.

Referring more particularly to the exemplary embodiments shown in the drawings, FIG. 2A is front view of a payment card 200, in accordance with an exemplary embodiment and FIG. 2B is a back view of the payment card 200 of FIG. 2A, in accordance with an example embodiment. The payment card may include some or all of the following features. The card may have multiple magnetic strips 202a-d. The brand 204 associated with the card may be displayed, as may the account number 206 and the security code and expiration date 208. A number of logos 210a-b corresponding to the types of services offered also may be shown.

### III. One Card that Can Access Credit, Checking, and/or Debit Account(s)

Certain exemplary embodiments relate to one card that can access one or more of each of a credit, checking, and/or debit account. According to certain exemplary embodiments, a card may provide certain dual network card features. Additionally or in the alternative, such cards may process both credit transactions (e.g., the customer is billed later), and debit transactions (e.g., where the money is debited from the user's checking account immediately or within a few hours or days, depending on the banking network). Furthermore, additionally or in the alternative, the card may debit any bank account. Currently, debit cards debit only the bank that is listed on the card.

A. Indicating “Credit” on a POS System

In certain exemplary implementations, when the consumer pushes credit at the POS system, the transaction is routed as a credit transaction in the manner that credit transactions are routed today—for example, the transaction may be routed through the merchant POS system, to the merchant processor, through the payment network (e.g., Visa, Mastercard, etc.) system to the appropriate Issuing Bank.

The Issuing Bank is identified by the “Bin Number,” which typically is represented by a series of digits that are part of the data format within a credit card transaction. The Issuing Bank's system authorizes the transaction and passes back the appropriate message code to authorize the transaction. Within the Issuing Bank's system, a determination may be made regarding the type of transaction (e.g., “credit” or “debit”). If the user pushes credit at the point of sale, the data within the transaction will indicate credit and, similarly, if the user pushes the debit button, the data within the transaction will indicate debit. With dual network cards today, such a determination is largely insignificant from a user's point of view as either transaction type is processed as a debit against the user's checking account regardless of the selection at the point of sale. The only impact with existing dual network cards of selecting debit or credit is that debit transactions are settled real-time via an online network and, when credit is pushed, the user's bank account is debited in batch via one of the credit networks, typically the next day.

However, according to certain exemplary implementations, when the user pushes credit, the approved transactions may be posted to the billing system just as a credit card transaction would be handled. And when the user pushes debit, the transaction may debit the user's checking account. In this latter case, it will be appreciated that the debit transaction may or may not be a real-time settlement, depending on, for example, the network that is utilized.

B. Indicating “Debit” on a POS System

When the consumer pushes debit, the POS may prompts for a PIN and send the transaction through the merchant POS system, the debit network, and ultimately pass the transaction to the issuing bank for authorization and processing. If the user's checking account resides with the bank that issued the card, the account would be debited in accordance with the network rules (e.g., either in real-time, in batch, etc.). If the user's checking account resides with a different bank, the transaction first may be approved similar to a credit transaction, and the user's checking account may be debited through the ACH network by processing a batch file at the end of the day.

C. Illustrative Flowchart

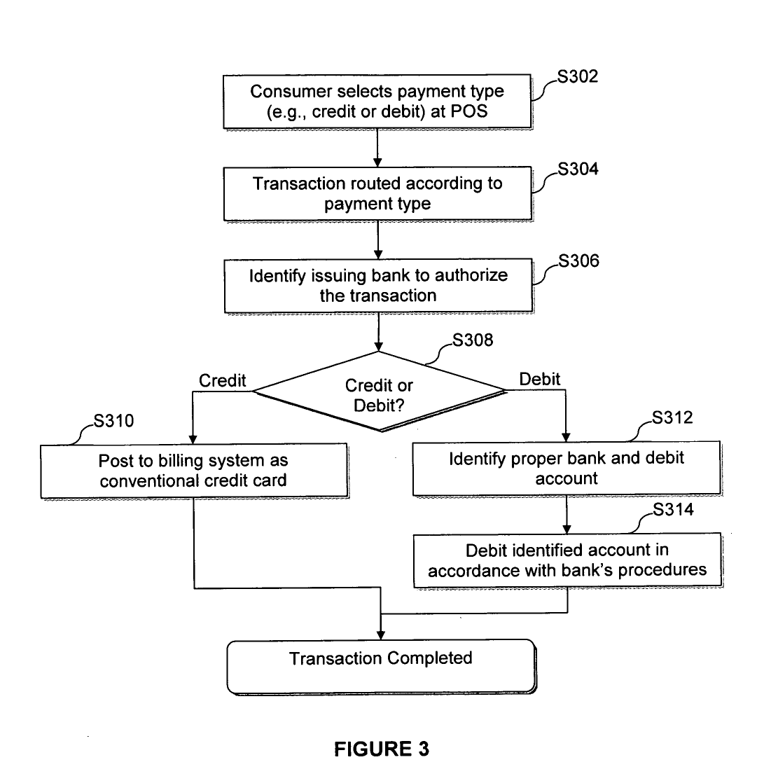

FIG. 3 is an illustrative flowchart showing a transaction involving a single card having access to multiple accounts, in accordance with an exemplary embodiment. The consumer selects the payment type (e.g., credit or debit) at the POS in step S302. In step S304, the transaction is routed according to the payment type. The issuing bank authorizing the transaction is identified in step S306. Depending on the payment type selected in step S302, step S308 instructs the system to post the credit to the billing system as a conventional credit card in step S310, or instructs the system to identify the proper bank and debit account in step S312. If this former option is chosen, the transaction is completed. If the latter option is chosen, before the transaction is completed, the additional step shown in step S314 is performed, as the identified account is debited in accordance with the bank's procedures.

### IV. Petty Cash Account

Certain exemplary embodiments relate to a petty cash account. Such a petty cash account may be a sub-account of the user's debit account, for example, to simplify tracking of transactions that are less than a user specified amount (e.g., $10, $15, etc.). In such a scenario, the user may activate this option via a website, or via an IVR calling system. To use the feature, the user simply pushes debit, and enters a PIN at the point of sale. When the transaction reaches the Issuing Bank, the system chooses an account based on the size of the transaction. For example, the system determines if the transaction size is less than the user-specified small transaction amount (e.g., $10, $15, etc.) and, if it is less than, or less than or equal to, the transaction threshold, the petty cash account is debited rather than the checking account. The account then works like other stored value accounts in that it automatically replenishes from a checking account when the balance reaches the system or user defined replenishment threshold (e.g., $10, $100, etc.) and debits the user's checking account (e.g., via ACH) for the replenishment amount (e.g., $40). Each time the account is used, the balance may be drawn down until the replenishment threshold is reached. As such, an automatic determination of which account to debit may be made based on the size of the transaction, as specified by the user and/or by the system.

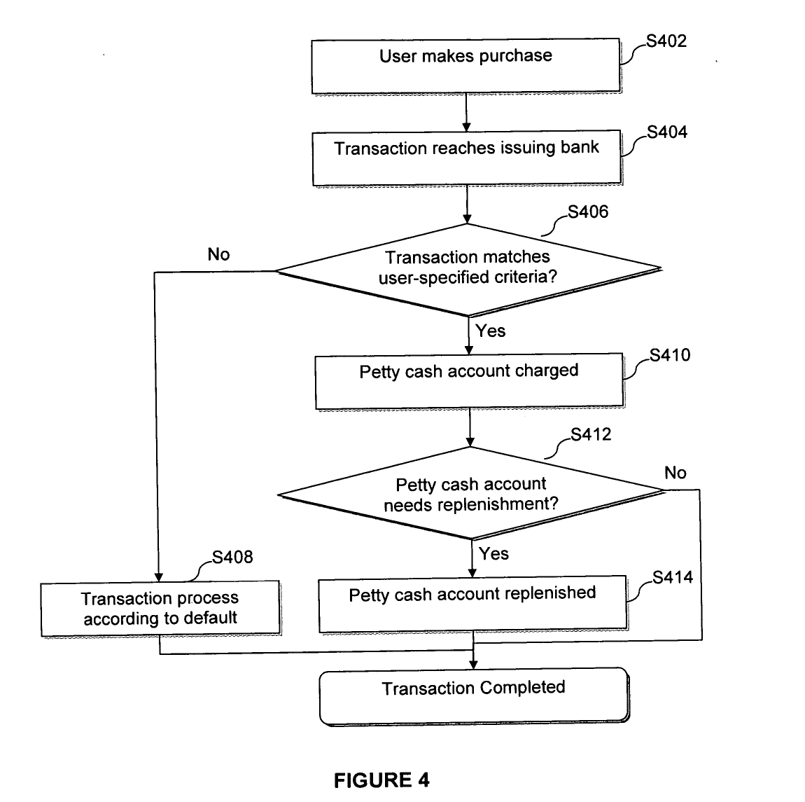

FIG. 4 is an illustrative flowchart showing a transaction where a petty cash sub-account is linked to another of the user's account and is accessible by a payment device, in accordance with an exemplary embodiment. In FIG. 4, the user makes a purchase in step S402. The transaction reaches the issuing bank in step S404. If the transaction fails to match user-specified criteria (e.g., price below a certain threshold, particular PIN entered, etc.) as determined in step S406, the transaction is processed as normal in step S408 and the transaction is then completed. However, if the transaction matches one or more user-specified criteria as determined in step S406, the petty cash account is charged in step S410. If it is determined that the petty cash account does not need replenishment in step S412, the transaction is completed. However, if it is determined that the petty cash account does need replenishment in step S412, the petty cash account may be replenished in step S414. It will be appreciated that the determination of whether the petty cash account needs replenishment may be made even if the petty cash account is not used. It also will be appreciated that in certain exemplary embodiments, the petty cash account replenishment determination may be made by the user rather than automatically and, furthermore, that the determination need not be automatic.

### V. Electronic Reward and Coupon Redemption

Certain exemplary embodiments relate to electronic reward and coupon redemption techniques. Consumers typically carry a number of identification cards and/or paper coupons in their wallets to exchange for credit at the point-of-sale. Most of these reward cards and coupons use bar codes for identification. Additionally, coupons are communicated through the newspaper and store circulars. Unfortunately, the collection and use of these coupons and reward programs is cumbersome. However, certain exemplary embodiments transform the basic methods of capturing and/or collecting of coupons and reward program identifiers, as well as the use or redemption of the rewards and coupons.

A. Collection of Coupons or Reward Code ID's

Certain exemplary embodiments relate to a device that enables the user to connect a small scanner (e.g., pen sized or smaller) that lets the user “scan-in” the bar codes for various reward cards and coupons. The device may be a stand-alone device, it may be attachable and/or integratable to another existing device (e.g., a cell phone, PDA, etc.), etc. After scanning in all of the coupons, the user may disconnect the scanner (e.g., if it is not embedded within the device).

Alternatively or in addition, an electronic file may be transmitted or downloaded to the device. The file may contain one coupon or reward code, or many coupons and reward codes. In certain exemplary embodiments, the file may be transmitted among and/or between mobile devices, stationary computers, databases, etc. In certain exemplary embodiments, the file may be downloaded via the Internet (e.g., by connecting the device to a computer, through a wireless connection, etc.).

Additionally, a user may categorize the coupon and/or memberships by type (e.g., food, clothing, prescriptions, etc.). The date and/or time of entry may be captured (e.g., indicating the length of validity, etc.). The device (or an interface usable in connection with the device) may enable the user to easily categorize coupons (e.g., for one time use) and reward cards (e.g., for repetitive uses).

B. Redemption and/or Use of Coupons and Reward Programs

As the user shops, prior to shopping, and/or at checkout, the user may “click” the applicable coupons to be redeemed by scrolling through the coupons on the device display and “marking” them for redemption. The user would be able to scan-in the coupons, and such reward card codes may have separate options for each to indicate “one-time” use or recurring use. The system may have a limit of the number of reward cards that could be scanned in to reduce the number of codes that could be used on a recurring basis. Thus, a user may be prevented from designating one-time use coupons as multiple-use reward card numbers.

When the user is finished shopping, the user may scroll through the coupons so that they will display on the device enabling the clerk (and/or the user) to scan from the display of the device at the cash register for credit. Certain exemplary embodiments may be configured such that existing POS scanners may be used to scan coupons from the device screen. And existing merchant systems may be used to scan coupons and reward card codes from the screen of the device. Similarly, in certain exemplary embodiments, membership programs and reward card codes may be presented in the form of bar codes so that users can receive discounts, points, and the like, for example, to access and/or receive program benefits.

Alternatively or in addition, some merchants may implement an automated interface to allow the user to transmit all coupons to the cash register system to be matched against purchases to get credit. For example, such an automated system may include a wireless-enabled device that receives a transmission of coupons and/or queries a user's device for matching coupons.

Alternatively or in addition, the coupon and/or reward code number may be read from the screen and to the clerk to enter into the point of sale system for redemption. This approach may enable a coupon to be redeemed even if the merchant did not have scanning equipment.

Within the merchant system, coupons and/or reward card codes may be verified (e.g., from bar code input). Conventional techniques may be maintained, requiring no further changes within the merchant system.

A timer within the stand alone device may be set from the time a coupon is marked to delete the coupon from the system once it has been used. Reward card codes generally need not be deleted (unless, for example, deleted by the user).

According to certain exemplary embodiments, one device may operate as a universal id and store and redeem coupons, while also providing identification for reward programs. This illustrative device may be integrated into other devices such as cell phones and personal organizers. In addition, coupons may be redeemed through the existing merchant scanning system, for example, by displaying bar codes on a screen of the cell phone, PDA, etc. Alternatively or in addition, the merchant could opt to implement an automated interface with the stand alone device, or the user could provide the numbers of the coupons or reward cards verbally to the clerk for manual input into the point of sale system.

C. Illustrative Flowchart

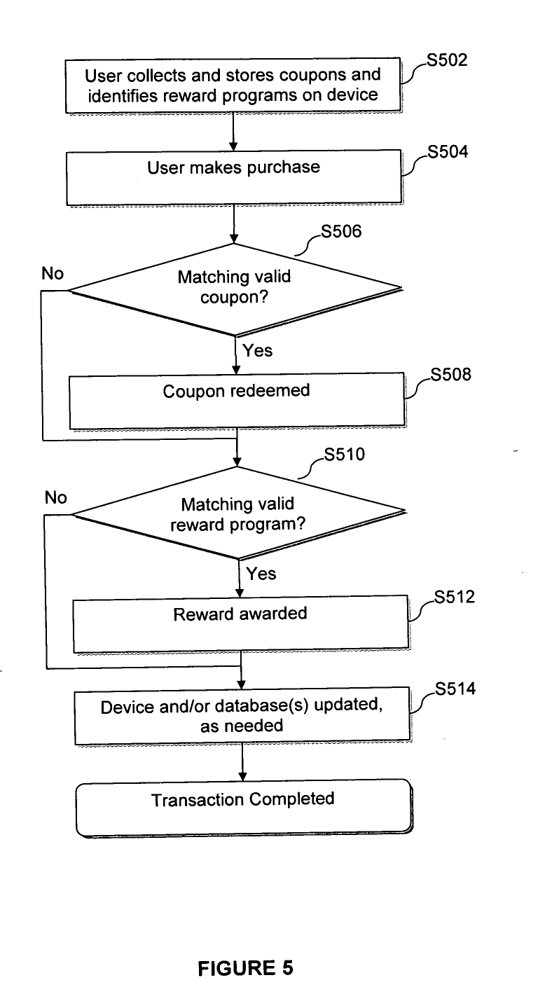

FIG. 5 is an illustrative flowchart showing a transaction where a single device stores one or more coupons and/or rewards programs, in accordance with an exemplary embodiment. In FIG. 5, the user collects and stores coupons and/or identifies reward programs on the device in step S502. The user makes a purchase in step S504. If it is determined that there is a matching valid coupon in step S506, the coupon is redeemed in step S508. Then (or in the case that there is no valid matching coupon), it is determined whether there is a matching valid rewards program in step S510. If there is, the reward is awarded in step S512. The device and/or a database stored on the device is/are updated, as needed, in step S514. Finally, the transaction is completed.

It will be appreciated that the process of determining whether there is a matching valid coupon and/or rewards program may be made automatically, by the user, by a store clerk, etc. It also will be appreciated that the process of redeeming coupons and/or seeking rewards may be used together (as just described), or may be used independently.

### VI. Automatic Links Among and/or Between Membership Programs

Certain exemplary embodiments relate to automatic links among and/or between membership programs. For example, a card account may be set-up to link a payment account number to multiple membership account numbers. A user may provide the reward membership numbers for programs that they wanted to have linked. If there is an agreement with the program to provide such a link, the user may be able to get their reward points and membership benefits, as well as make payments automatically. This may be carried out by linking the payment account number to the reward code membership number in the database of the system. When the transaction reaches the Issuing Bank processing system, the device id may be matched to a payment account and the payment account matched to the reward or membership id. The membership id may be returned to the merchant by packing the merchant's membership id number into the message format of the standard credit or debit transaction. The merchant may strip the id number out and process the transactions as if the reward card had been presented.

Thus, in certain exemplary embodiments, a payment account number may be automatically linked with one or more reward or membership accounts. Program identification numbers may be passed back to the merchant via the card system by packing the number into the existing format.

### VII. Rules-Based Account Limits and/or Alerts

Certain exemplary embodiments relate to rules-based account limits and/or alerts. For example, a user may specify a limit for each device or card, a warning amount, and/or a type of transaction to be rejected or monitored. In particular, the user may use a website, IVR, or the like to specify the user's preferences and may identify, for example, the cap amount, the type of transaction, whether to reject or “warn,” and the device. For example, the user might specify that all transactions over $500 for a certain card number should be rejected. As another example, the user may request that a voice mail, email, or text message alert be sent when such a situation occurs for a specific device or card. Alternatively or in addition, the user may specify that when purchases for a certain device or card reach a predetermined threshold during a particular time interval (e.g., $1,000 during a month) that all transactions should be rejected and a notification should be sent. In addition to the amount of a transaction and/or cumulative amounts, the user may specify a type of transaction by merchant category, foreign vs. domestic, etc. Once again, the user may specify that the transaction should be rejected, request a “warning” for the account holder, etc. By way of example and without limitation, the rules may be stored in a database, e.g., accessibly by the product system 100 of FIG. 1.

Consumer users therefore may benefit by having greater peace of mind and fewer fraudulent and unwanted authorized transactions (e.g., children abusing purchase privileges). Banks also may benefit by essentially transferring much of the fraud monitoring responsibilities to the system and the user. The cost of monitoring may decrease, as may the total system fraud.

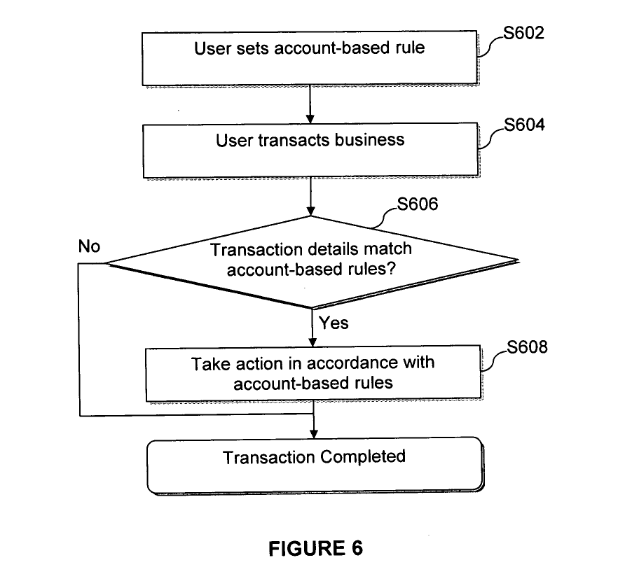

FIG. 6 is an illustrative flowchart showing a transaction limited by one or more user-specified rules. In FIG. 6, the user sets one or more account-based rules in step S602. The user transacts business in step S604. In step S606, it is determined whether details of the transaction match any of the account-based rules. Rules may include, for example, daily/monthly/etc. purchasing restrictions, geographic purchasing restrictions, simultaneous use restrictions, etc. If there is no match, the transaction is completed. However, if there is a match, an action is taken in accordance with any matching account-based rules in step S608. A suitable action may include, for example, denying the transaction, sending an alert to the payment device owner (e.g., an e-mail, phone call, text message, etc.), etc.

### VIII. Real-Time Transactions

Certain exemplary embodiments relate to real-time transactions (e.g., real-time transaction via mobile devices). In particular, certain exemplary embodiments relate to electronic portals (e.g., facilitated via webpages or the like) that make available transactional information to, for example, a mobile device in real-time. Thus, a user with a suitably configured mobile device (e.g., a web-enabled mobile device) may be able to view transactions in real-time by accessing an account integrated into and/or accessibly by the system of certain exemplary embodiments.

### IX. Computer-Readable Storage Medium Payment Token

Certain exemplary embodiments relate to computer-readable storage medium payment tokens. According to certain of these exemplary embodiments, device may comprise a computer-readable storage medium (e.g., a USB key, flash memory card, disk, etc.) having stored thereon account information. Other devices may comprise a cell phone, PDA, or the like having a suitable computer interface (e.g., wireless, infrared, wired, or other connections). Such devices could be used to access an account for a certain class of purchases (e.g., Internet purchases, large one-time purchases, etc.), particularly purchases made via a computer.

In certain illustrative implementations, the device may include hardware and/or software that allows the user to plug the device into a port of the user's computer and allows the user to setup personal information to be stored on the device. When the user wants to pay, a function key on the computer, device, or both may be pushed to transfer the information from the device to the computer and/or, for example, from the computer to the payment system. All personal information (e.g., delivery address, payment account number, expiration date for processing through a given website, etc.) may be transmitted. Such exemplary embodiments may reduce the need to enter personal information every time a user wants to make a purchase.

In certain other illustrative implementations, a computer to which the device connects effectively may function as a terminal. In particular, an account designated by the user may be debited for the amount of the transaction. The product system may dynamically create a stored value account with the appropriate bin range for the amount of the transaction, credit the stored value account for the transaction amount, and return that information back to the users PC screen. The user then may submit the information for payment to the online merchant. The account number on the user's screen should be a valid account number (e.g., credit card account number) for the user's bank and payment network. The transaction may flow through the payment system back to the product system (e.g., to approve the transaction). After the transaction is settled, the stored value account may be deleted from the system and not used again, and the deletion may be permanent and/or may be merely disabled for a predetermined (e.g., user-specified) time.

Thus, according to certain exemplary embodiments, computer-readable storage medium payment tokens may provide secure payment authentication. Additionally or in the alternative, the user's account number may be shared directly with the product host (e.g., in a secure format) rather than being sent through the merchant system, potentially reducing the proliferation (e.g., transmission and/or exposure of existing, creation of new, etc.) account numbers. Also, in addition or in the alternative, the payment account pushed through the merchant processing system may be created dynamically and/or not re-used for a predetermined period of time (e.g., six months), during which time the account number would be inactive. By way of example and without limitation, the rules may be stored in a database, e.g., accessibly by the product system 100 of FIG. 1.

### X. Mechanism for Confirming Payment with a Payment Device

Certain exemplary embodiments relate to a mechanism for confirming payment with a payment device. Payment devices having RFID technology may function by having a user simply wave a suitably configured payment card near a payment card reader, and charging a specified account. However, because such cards and/or tokens configured in these ways may be passively read, a user is at risk that personal data could be read from the payment device without the user's knowledge. Information could be intercepted in a variety of ways. For example, an antenna coupled to an intelligent reader may intercept the signal, and software could read and/or decrypt data on the card without the user's knowledge.

To reduce the likelihood of this and/or other similar situations, certain exemplary embodiments may include a mechanism for confirming that a payment should be made and/or that data should be transmitted. For example, a button may be added to a payment device or card that restricts transmissions therefrom unless the button is depressed. For example, the device and/or card may only transmit data while the button is depressed or a short time after the button is depressed (e.g., after the button is depressed but shortly before the device is presented for payment, or within 2 seconds of the button being depressed, etc.). In certain other exemplary embodiments, other mechanisms including, for example, a switch (e.g., a on/off or other suitable binary transmit/no-transmit toggle) may be implemented.

The transmission of any data may be prevented unless and/or until a transmission-enabling mechanism is activated. It will be appreciated that the transmission-enabling mechanism may be implemented as software, hardware, or both. For example, such a mechanism may comprise a hardware switch that breaks the antennae loop unless and/or until the switch is activated, or a removable and/or adjustable shield that serves to block transmissions.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A payment instrument comprising a card on which at least two account identifiers are disposed, each said account identifier being disposed proximate to an edge of the card.

2. The payment instrument of claim 1, wherein the account identifiers are magnetic strips.

3. The payment instrument of claim 1, wherein the payment instrument comprises two account identifiers disposed on one side of the card proximate to each opposing edge of the card.

4. The payment instrument of claim 1, wherein the payment instrument comprises two account identifiers disposed on opposing sides of the card proximate to a one edge of the card.

5. The payment instrument of claim 1, wherein the payment instrument comprises four account identifiers, two account identifiers being disposed on a first side of the card proximate to each opposing edge of the first side of the card, and two account identifiers being disposed on a second side of the card proximate to each opposing edge of the second side of the card.

6. The payment instrument of claim 1, wherein each account identifier is associated with a single account.

7. A product system operable to route a transaction in dependence on a payment type selected by a user at a point-of-sale after the user presents a single payment instrument at the point-of-sale, wherein:
when the payment type is indicative of a credit transaction, the product system is configured to route the transaction by posting the transaction to a billing system as a credit card transaction; and,
when the payment type is indicative of a debit transaction, the product system is configured to route the transaction by identifying a debit account and a bank associated with the debit account and debiting the identified debit account in accordance with procedures of the identified bank.

8. The product system of claim 7, wherein the product system is further configured to identify a first debit account and a first bank associated with the first debit account from among a plurality of debit accounts associated with one or more banks, each debit account being accessible by the user, the first debit account associated with the first bank being the debit account to be debited by the product system.

9. A single payment instrument for use with the product system of claim 7.

10. A method of routing a payment transaction, the method comprising:
receiving a payment type at a point-of-sale; and,
routing the payment transaction in dependence on the selected payment type; wherein
when the selected payment type is a credit, posting the payment transaction to a billing system as a credit card transaction; and,
when the selected payment type is a debit:
identifying a debit account and a bank associated with the debit account; and,
debiting the identified bank account in accordance with procedures of the identified bank.

11. The method of claim 10, further comprising receiving an authorization to process the payment transaction.

12. The method of claim 10, further comprising receiving an input indicating the credit or debit account to be charged from among a plurality of credit and/or debit accounts associated with a payment instrument presented at the point-of-sale.

13. A method of routing a payment transaction initiated by a user at a point-of-sale, the method comprising:
receiving details of the payment transaction from a point-of-sale system;
determining whether the payment transaction details match one or more criteria specified by the user in advance of the payment transaction; and,
when there is a match, charging a sub-account of a main account associated with a payment instrument presented by the user at the point-of-sale, and
when there is not a match, charging the main account associated with the payment instrument presented by the user.

14. The method of claim 13, further comprising when the sub-account drops below a threshold level of funds, replenishing the sub-account with funds from the main account.

15. The method of claim 13, wherein the criteria includes one or more of an amount of the payment transaction initiated by the user, a identification number input by the user at the point-of-sale, a number of payment transactions initiated by the user, and a time period during which a payment transaction may be initiated by the user.

16. The method of claim 13, wherein the sub-account is a petty cash account.

17. A payment instrument associated with an bank account, comprising:
a transmitter for wirelessly transmitting information about the bank account to a point-of-sale system to complete a payment transaction, and
transmission enabling logic circuitry having a first state indicative of enabled transmission and a second state indicative of disabled transmission;
wherein the transmitter is configured to transmit the bank account information in dependence on the state of the transmission enabling logic circuitry.

18. The payment instrument of claim 17, further comprising a button, and wherein the transmission enabling logic circuitry enables transmission of the bank account information only when the button is depressed.

19. The payment instrument of claim 17, further comprising a button, and wherein the transmission enabling logic circuitry enables transmission of the bank account information only within a predetermined time interval of when the button is depressed.

20. The payment instrument of claim 17, further comprising a switch, and wherein the transmission enabling logic circuitry enables transmission of the bank account information only when the switch is turned on.
